(19) United States
(12) Patent Application Publication
(10) Pub. No.: US 2024/0176901 A1
(43) Pub. Date: May 30, 2024

(54) SIMULATING INTERFACE SYSTEM

(71) Applicant: Lanto Electronic Limited, Kunshan City (CN)

(72) Inventors: Chih-Hsiung CHANG, Taipei City (TW); Chih-Wei SUN, Taipei City (TW); Chia-Ching LIN, Taipei City (TW)

(73) Assignee: Lanto Electronic Limited, Kunshan City (CN)

(21) Appl. No.: 18/518,843

(22) Filed: Nov. 24, 2023

(30) Foreign Application Priority Data
Nov. 24, 2022 (CN) 202211495994.X

(51) Int. Cl. G06F 21/60

(52) U.S. Cl. CPC G06F 21/604

(57) ABSTRACT

The present disclosure discloses a simulating interface system, which is assembled with an electronic device and has an interface module and a simulating module. The interface module is connected with an external electronic device, and receives connection signals from the external electronic device; and the simulating module is connected with the interface module, and has a simulating unit and a management unit, wherein the simulating unit is used to simulate a use authority of the electronic device, and the management unit adjusts the use authority to provide to the external electronic device based on the connection signals. The simulating unit analogizes the use authority of the electronic device, and the management unit adjusts the use authority to provide to the external electronic device based on the connection signals from the external electronic device, so as to achieve effective protection.

### CROSS REFERENCE TO RELATED APPLICATION

This application claims the priority benefits of Chinese Patent Application Serial Number 202211495994.X, filed on Nov. 24, 2022, the full disclosure of which is incorporated herein by reference.

### BACKGROUND

### Technical Field

The present disclosure is in related to the technical field of the interface of an electronic device, more particularly to a simulating interface system.

### Related Art

Presently, for connecting an external electronic device, the basic use authorities of the connection interface of an electronic device are totally opened or restricted after settings. The electronic device cannot define the functions of a permission provided by the connection interface based on the user permission of an external electronic device. In other words, the electronic device cannot provide different permissions to a specific electronic device for individually restricting and opening data accessing permissions. Aforesaid method of use cannot particularly set to the place of use or the user. It lacks security in use and is quite inconvenient in management, so as to result in information security loopholes.

### SUMMARY

The present disclosure discloses a simulating interface system, which provides a solution that a single electronic device can be with different use conditions, and such solution is not appeared than ever.

For achieving aforesaid solution, the descriptions for the simulating interface system are as following.

The simulating interface system, which is assembled with an electronic device and has an interface module and a simulating module. The interface module is connected with an external electronic device, and receives connection signals from the external electronic device; and the simulating module is connected with the interface module, and has a simulating unit and a management unit, wherein the simulating unit is used to simulate a use authority of the electronic device, and the management unit adjusts the use authority to provide to the external electronic device based on the connection signals.

One of the embodiment is described as following. The connection signals has device information of the external electronic device, and the management unit has a device permission list. The management unit compares the device information according to the device permission list, in order to open or restrict the use authority of the electronic device.

One of the embodiment is described as following. The use authority has functional permissions and/or specification permissions.

One of the embodiment is described as following. The functional permissions have video signal inputs, video signal outputs, audio signal inputs, audio signal outputs, data inputs, and/or data outputs.

One of the embodiment is described as following. The specification permissions have video input specifications, video output specifications, audio input specifications, audio output specifications, upload data specifications, and/or download data specifications.

One of the embodiment is described as following. The interface module has a plurality of interface units, each of which has a display interface unit, an audio interface unit and a data transfer interface unit.

One of the embodiment is described as following. The plurality of interface units are selected from the group consisting of: USB, micro USB, DP, HDMI, DVI, and VGA.

One of the embodiment is described as following. The simulating interface system further has a connection module, which is connected with the simulating module and a connection interface of the electronic device.

One of the embodiment is described as following. The connection module is selected from the group consisting of: USB, micro USB, DP, HDMI, DVI, and VGA.

One of the embodiment is described as following. The simulating module is disposed in the electronic device, and the interface module corresponds to a connection interface of the electronic device.

The present disclosure provides a simulating interface system. The simulating unit analogizes the use authority of the electronic device, and the management unit adjusts the use authority to provide to the external electronic device based on the connection signals from the external electronic device. A specific and trusted electronic device is thus opened for the use authority thereof. On the contrary, for electronic devices that are not frequently used, their use authorities are restricted, so as to achieve effective protection for the electronic devices.

The accompanying drawings are incorporated in and constitute a part of this application and, together with the description, serve to explain the principles of the disclosure in general terms. Like numerals refer to like parts throughout the disclosure.

It should be understood, however, that this summary may not contain all aspects and embodiments of the present disclosure, that this summary is not meant to be limiting or restrictive in any manner, and that the disclosure as disclosed herein will be understood by one of ordinary skill in the art to encompass obvious improvements and modifications thereto.

### BRIEF DESCRIPTION OF THE DRAWINGS

The features of the exemplary embodiments believed to be novel and the elements and/or the steps characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows taken in conjunction with the accompanying drawings in which:

FIG. 1 illustrates a schematic structural block view of a simulating interface system of the present disclosure;

FIG. 2 illustrates a schematic structural block view of a first embodiment of the simulating interface system assembled with an electronic device of the present disclosure; and

FIG. 3 illustrates a schematic structural block view of a second embodiment of the simulating interface system assembled with an electronic device of the present disclosure.

### DETAILED DESCRIPTION OF THE EMBODIMENTS

The present disclosure will now be described more fully hereinafter with reference to the accompanying drawings, in which exemplary embodiments of the disclosure are shown. This present disclosure may, however, be embodied in many different forms and should not be construed as limited to the embodiments set forth herein. Rather, these embodiments are provided so that this present disclosure will be thorough and complete, and will fully convey the scope of the present disclosure to those skilled in the art.

Certain terms are used throughout the description and following claims to refer to particular components. As one skilled in the art will appreciate, manufacturers may refer to a component by different names. This document does not intend to distinguish between components that differ in name but function. In the following description and in the claims, the terms “include/including” and “comprise/comprising” are used in an open-ended fashion, and thus should be interpreted as “including but not limited to”. “Substantial/substantially” means, within an acceptable error range, the person skilled in the art may solve the technical problem in a certain error range to achieve the basic technical effect.

The following description is of the best-contemplated mode of carrying out the disclosure. This description is made for the purpose of illustration of the general principles of the disclosure and should not be taken in a limiting sense. The scope of the disclosure is best determined by reference to the appended claims.

Moreover, the terms “include”, “contain”, and any variation thereof are intended to cover a non-exclusive inclusion. Therefore, a process, method, object, or device that includes a series of elements not only includes these elements, but also includes other elements not specified expressly, or may include inherent elements of the process, method, object, or device. If no more limitations are made, an element limited by “include a/an . . . ” does not exclude other same elements existing in the process, the method, the article, or the device which includes the element.

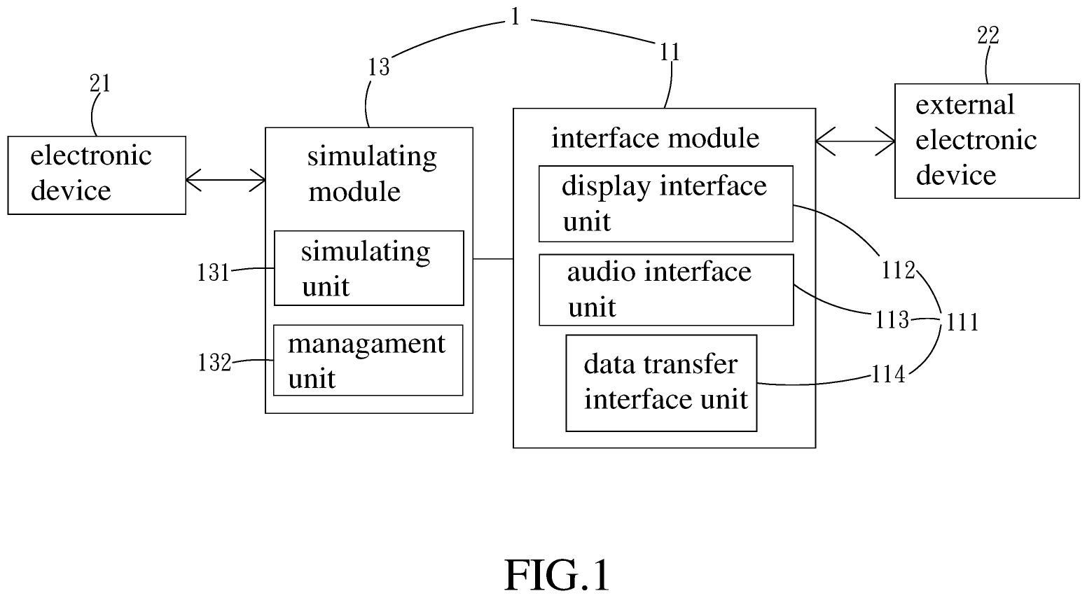

Please refer to FIG. 1, which illustrates a schematic structural block view of a simulating interface system of the present disclosure. As shown in FIG. 1, a simulating interface system 1 is assembled with an electronic device 21 and includes an interface module 11 and a simulating module 13. The interface module 11 connects with an external electronic device 22 and receives connection signals from the external electronic device 22. The simulating module 13 connects with the interface module 11 and includes a simulating unit 131 and a management unit 132, wherein the simulating unit 131 is used to simulate a use authority of the electronic device 21, and the management unit 132 adjusts the use authority to provide to the external electronic device 22 based on the connection signals.

For the present embodiment, the electronic device 21 has the simulating interface system 1, and is a desktop computer, a laptop computer, a mobile phone, etc. The external electronic device 22 is a monitor, a music player, a portable hard disk, etc. The external electronic device 22 connects with the simulating interface system 1 of the electronic device 21 first, and the external electronic device 22 may send the connection signals to the simulating interface system 1. The connection signals from the external electronic device 22 are transmitted to the simulating module 13 via the interface module 11, and the connection signals have device information of the external electronic device 22. Further, the management unit 132 in the simulating module 13 receives the connection signals for processing in advance. The management unit 132 has a device permission list and compares the device permission list with the device information of the external electronic device 22 to open or restrict the use authority of the electronic device 21. The electronic device 21 connects with the simulating interface system 1 for adjusting internal settings of the simulating interface system 1. The user is able to adjust the device permission list of the management unit 132 through the electronic device 21, and further set different permission settings for the use use authority that can be obtained by the external electronic device 22 in the device permission list, namely the electronic device 21 can provide different use authorities for the different external electronic devices 22.

About the embodiment, the use authority of the electronic device 21 has functional permissions and/or specification permissions, wherein the functional permissions are video signal inputs, video signal outputs, audio signal inputs, audio signal outputs, data inputs, and/or data outputs, and the specification permissions are video input specifications, video output specifications, audio input specifications, audio output specifications, upload data specifications, and/or download data specifications. Presently, to adjust the functional permissions right of the use authority refers to one or a combination of permissions that restrict video signal inputs, video signal outputs, audio signal inputs, audio signal outputs, data inputs, and data outputs. In other words, when the use authority of the video signal inputs and the video signal outputs are restricted, any function of the video signal inputs and the video signal outputs between the electronic device 21 and the external electronic device 22 is thus closed. Therefore, the information received by the external electronic device 22 from the electronic device 21 is the information of a device that does not have the functions of the video signal inputs and the video signal outputs. The limitation of this embodiment on the functional permissions is to directly disable those functions.

In this embodiment, the specification permissions for adjusting use authority means reducing one or a combination of the permissions for video input specifications, video output specifications, audio input specifications, audio output specifications, upload data specifications, and download data specifications. In other words, when reducing the use authorities of the video input specifications and the video output specification, it means that lowering the resolution of the display screens of the electronic device 21 and the external electronic device 22 cannot provide clearer images. Further, when downgrading the use authorities of the audio input specifications and the audio output specifications, it represents that reducing the sound quality effects of the electronic device 21 and the external electronic device 22, etc. is not able to play audio files with relative original sound quality. More, if the use authorities of the upload data specifications and the download data specifications are degraded, the data transmission rate between the electronic device 21 and the external electronic device 22 is lowered down, and the upload or download traffic cannot be fully opened, so as to limit the speed of file upload and file download. To decrease the specification permission discussed in the embodiment is to restrict the whole function of one of the specification permissions, but not totally close the function.

In the embodiment, the interface module 11 has a plurality of interface units 111, each of which has a display interface unit 112, an audio interface unit 113 and/or a data transfer interface unit 114. The display interface unit 112 is connected with a display as video player. The audio interface unit 113 is capable of connecting to sound playback devices, such as speakers, audio equipment, etc. The data transfer interface unit 114 is connected with access devices as hard drives. The interface unit 111 can be various types of USB, micro USB, DP, HDMI, DVI, VGA, etc. This embodiment does not limit the type of the connection structure of the interface unit 111 and it can be adjusted according to the needs of users. The plurality of interface units 111 in this embodiment are not limited to a single type of interface or a combination of multiple different interfaces.

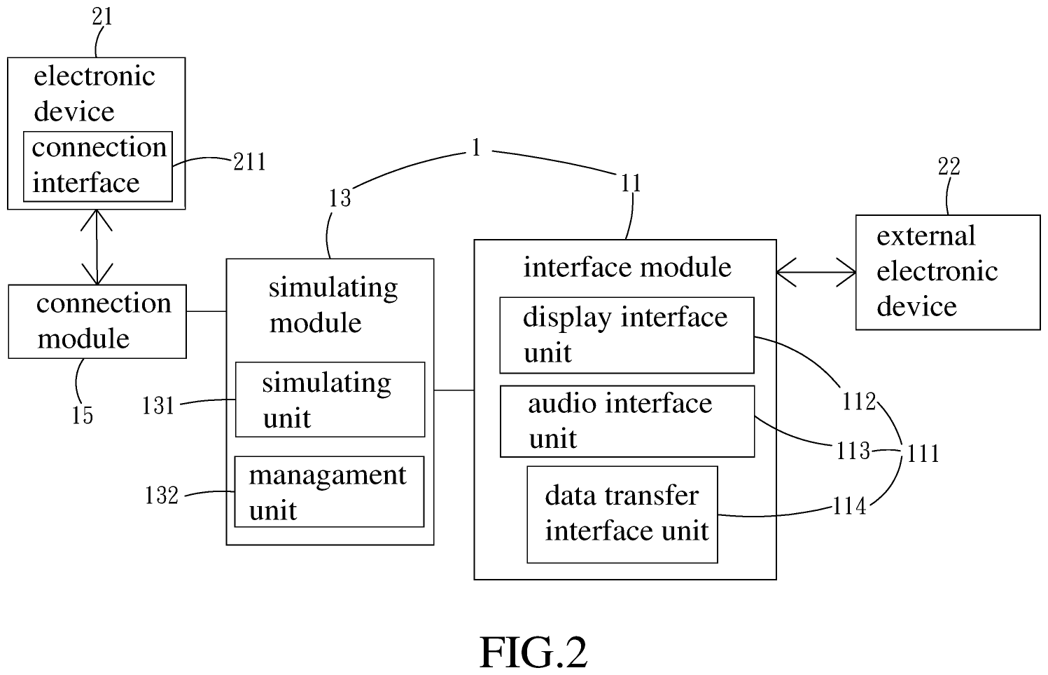

With reference to FIG. 2, which illustrates a schematic structural block view of a first embodiment of the simulating interface system assembled with an electronic device of the present disclosure. As shown in FIG. 2, the simulating interface system 1 further has a connection module 15, which is connected with the simulating module 13 and a connection interface 211 of the electronic device 21, wherein the connection module 15 is selected from the group consisting of: USB, micro USB, DP, HDMI, DVI, and VGA. With the electronic device 21, the simulating interface system 1 is an external device for the application of the embodiment. Therefore, the simulating interface system 1 is externally connected with the electronic device 21 through the connection module 15 Obviously, the embodiment is good of the simulating interface system 1 assembling with various types of electronic devices 21.

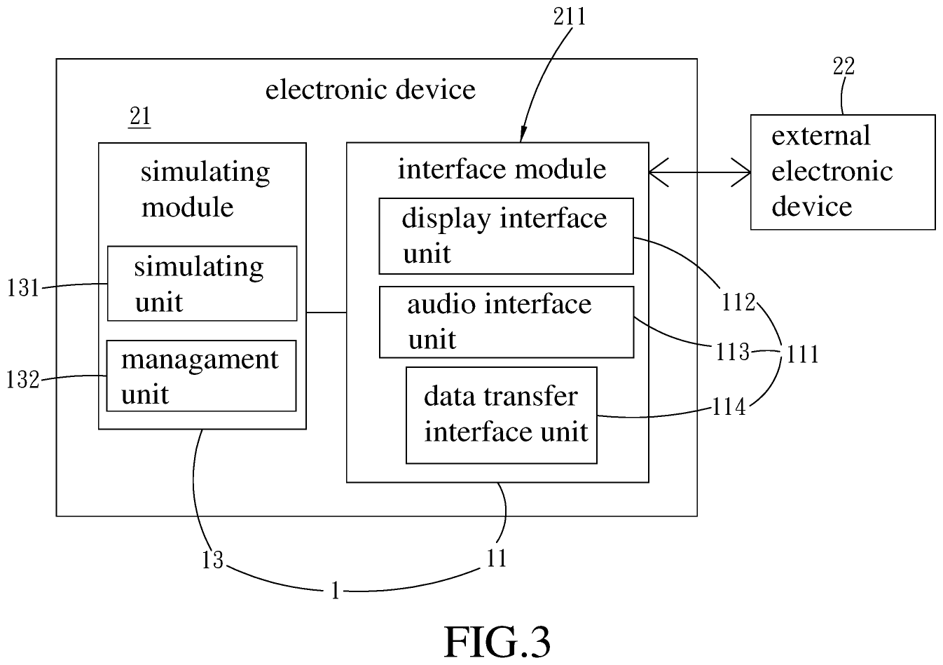

With reference to FIG. 3, which illustrates a schematic structural block view of a second embodiment of the simulating interface system assembled with an electronic device of the present disclosure. The difference between the second embodiment and the first embodiment is an assembling position for the simulating interface system. According to the embodiment, the simulating module 13 is disposed in the electronic device 21, and the interface module 11 corresponds to a connection interface 211 of the electronic device 21. That is to say, the interface module 11 of the simulating interface system 1 is the role as the connection interface 211, which is the device for the electronic device 21 connecting to outwardly. According to the electronic device 21, the simulating interface system 1 of the embodiment is a built-in device. It seems that, the assembled application of the simulating interface system 1 and the electronic device 21 is more effective based on the present embodiment.

As a conclusion, the present disclosure provides a simulating interface system. The simulating unit analogizes the use authority of the electronic device, and the management unit adjusts the use authority to provide to the external electronic device based on the connection signals from the external electronic device. A specific and trusted electronic device is thus opened for the use authority thereof. On the contrary, for electronic devices that are not frequently used, their use authorities are restricted, so as to achieve effective protection for the electronic devices.

Although the present disclosure is disclosed in the foregoing embodiments, it is not intended to limit the present disclosure. Changes and modifications made without departing from the spirit and scope of the present disclosure belong to the scope of the claims of the present disclosure. The scope of protection of the present disclosure should be construed based on the following claims.

What is claimed is:

1. A simulating interface system, assembled with an electronic device, comprising:
an interface module connecting with an external electronic device and receiving connection signals from the external electronic device; and
a simulating module connecting with the interface module and comprising a simulating unit and a management unit, wherein the simulating unit is used to simulate a use authority of the electronic device and the management unit adjusts the use authority to provide to the external electronic device based on the connection signals.

2. The simulating interface system according to claim 1, wherein the connection signals comprise device information of the external electronic device and the management unit comprises a device permission list, the management unit compares the device information according to the device permission list, in order to open or restrict the use authority of the electronic device.

3. The simulating interface system according to claim 1, wherein the use authority comprises functional permissions and/or specification permissions.

4. The simulating interface system according to claim 3, wherein the functional permissions comprise video signal inputs, video signal outputs, audio signal inputs, audio signal outputs, data inputs, and data outputs.

5. The simulating interface system according to claim 3, wherein the specification permissions comprise video input specifications, video output specifications, audio input specifications, audio output specifications, upload data specifications, and download data specifications.

6. The simulating interface system according to claim 1, wherein the interface module comprises a plurality of interface units each of which has a display interface unit an audio interface unit and a data transfer interface unit.

7. The simulating interface system according to claim 6, wherein the plurality of interface units are selected from the group consisting of: USB, micro USB, DP, HDMI, DVI, and VGA.

8. The simulating interface system according to claim 1 further comprising a connection module which is connected with the simulating module, wherein the connection module is configured to connect a connection interface of the electronic device.

9. The simulating interface system according to claim 8, wherein the connection module is selected from the group consisting of: USB, micro USB, DP, HDMI, DVI, and VGA.

10. The simulating interface system according to claim 1, wherein the simulating module is disposed in the electronic device and the interface module corresponds to a connection interface of the electronic device.
